(19) United States
(12) Patent Application Publication
(10) Pub. No.: US 2024/0328473 A1
(43) Pub. Date: Oct. 3, 2024

(54) CALIPER BRAKE

(71) Applicant: HL MANDO CORPORATION, Pyeongtaek (KR)

(72) Inventor: Hatem SHAHIN, Pfaffenhofen (DE)

(21) Appl. No.: 18/544,540

(22) Filed: Dec. 19, 2023

(30) Foreign Application Priority Data
Mar. 31, 2023 (DE) 102023202941.3

(51) Int. Cl. F16D 65/18; F16D 55/225

(52) U.S. Cl. CPC F16D 65/18; F16D 55/225; F16D 2121/04; F16D 2125/06; F16D 2125/08

(57) ABSTRACT

The caliper brake includes a carrier on which a pair of pad plates are installed to be able to move forward to and backward from a disc, a caliper housing slidably installed on the carrier and provided with a cylinder, a piston installed in the cylinder and provided to be able to move forward to and backward from the pair of pad plates, a seal groove formed to be recessed in an inner surface of the cylinder, a seal member accommodated in the seal groove to be in close contact with an outer surface of the piston, and a support member interposed between the inner surface of the cylinder and the outer surface of the piston and disposed adjacent to a center of gravity of the piston.

### CROSS-REFERENCE TO RELATED APPLICATION

This application claims the benefit of German Patent Application No. 102023202941.3, filed on Mar. 31, 2023, in the German Patent Office (DPMA), the disclosures of which are incorporated herein by reference in its entirety.

### BACKGROUND

### 1. Technical Field

Embodiments of the present disclosure relate to a caliper brake, and more particularly, to a caliper brake with improved durability by minimizing structural deformation.

### 2. Description of the Related Art

A vehicle necessarily includes a brake system for braking. As a typical brake system, there is a caliper brake. The caliper brake includes a disc that rotates together with a car wheel, a piston mounted on the side of the disc and operated hydraulically or electronically, and brake pads.

Specifically, in the caliper brake, when a driver steps on a brake pedal, the piston moves inward, and the brake pads tighten the disc inward to generate a frictional force, which is used as a braking force.

In general, the caliper brake is provided with a piston seal made of an elastic material. The piston seal provides an elastic restoring force to the piston to help the piston to return to its original position after completion of movement.

The piston seal is positioned close to a pad plate to seal a space between the piston and a cylinder provided inside a caliper housing, thereby restricting the flow of a brake fluid. Therefore, the piston seal is positioned away from the center of gravity of the piston.

In particular, when the vehicle maintains a driving or braking state, the piston seal and the center of gravity of the piston are maintained at a specific distance apart. Therefore, an external force of the same direction and magnitude, which is generated by a weight of the piston, is continuously applied to the piston seal.

However, since the piston seal is made of an elastic material, its durability is weak. Therefore, the piston seal in the related art is easily deformed only by the external force generated by the weight of the piston. The deformed piston seal does not come into close contact with the piston, and as a consequence, the piston seal does not provide a full elastic restoring force to the piston.

Accordingly, a method for minimizing the deformation of the piston seal of the caliper brake which is generated by the weight of the piston is required.

Examples of the related art include Korean Patent Registration No. 10-2032723 (registered on Oct. 10, 2019).

### SUMMARY

Therefore, it is an aspect of the present disclosure to provide a caliper brake with improved durability.

It is another aspect of the present disclosure is to provide a caliper brake that prevents deformation of a seal member.

It is still another aspect of the present disclosure is to provide a caliper brake that allows a seal member to provide a full elastic restoring force to a piston.

It is yet another aspect of the present disclosure is to provide a caliper brake that improves the marketability and competitiveness of a vehicle.

Additional aspects of the disclosure will be set forth in part in the description which follows and, in part, will be obvious from the description, or may be learned by practice of the disclosure.

In accordance with one aspect of the present disclosure, caliper brake includes a carrier on which a pair of pad plates are installed to be able to move forward to and backward from a disc, a caliper housing slidably installed on the carrier and provided with a cylinder, a piston installed in the cylinder and provided to be able to move forward to and backward from the pair of pad plates by braking hydraulic pressure, a seal groove formed to be recessed in an inner surface of the cylinder, a seal member accommodated in the seal groove to be in close contact with an outer surface of the piston, and a support member interposed between the inner surface of the cylinder and the outer surface of the piston and disposed adjacent to a center of gravity of the piston.

The support member may be disposed on an extension line perpendicular to an axial direction of the piston and passing through the center of gravity of the piston.

The caliper brake may further include a support member groove formed to be recessed in the inner surface of the cylinder so that the support member is accommodated therein.

The support member may be provided in a form of a seal made of an elastic material.

One surface of the support member may be fixed to the outer surface of the piston, and the other surface of the support member may be in close contact with the inner surface of the cylinder.

The support member may be formed so that a center thereof protrudes outward from an edge thereof to allow a part of the other surface to be in contact with the inner surface of the cylinder.

The support member may be accommodated in the support member groove so that one surface thereof is fixed to the inner surface of the cylinder, and the other surface of the support member may be in close contact with the outer surface of the piston.

The support member may be accommodated in the support member groove, and one surface of the support member may be fixed to the inner surface of the cylinder, and the other surface of the support member may be in close contact with the outer surface of the piston.

The support member may be provided in an annular shape along the outer surface of the piston.

A plurality of support members may be provided to be disposed spaced apart from each other along an axial direction of the piston.

A plurality of support members may be provided to be disposed spaced apart from each other around an outer circumferential surface of the piston.

The support members may be symmetrically disposed with respect to the center of gravity of the piston.

The support members may be radially symmetrically disposed with respect to an axis of the piston.

The support member may be provided in a form of a rib extending in an axial direction of the piston.

A plurality of support members may be provided as a mix of a form of a seal made of an elastic material and a form of a rib extending in an axial direction of the piston.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a cross-sectional view showing an inside of a caliper brake in the related art;

FIG. 2 is a cross-sectional view showing an inside of a caliper brake in accordance with a first embodiment of the present disclosure when viewed from the side;

FIG. 3 is a cross-sectional view showing an inside of the caliper brake in accordance with a second embodiment of the present disclosure when viewed from the side;

FIG. 4 is a cross-sectional view showing the inside of the caliper brake in accordance with the second embodiment of the present disclosure when viewed from the front;

FIG. 5 is a cross-sectional view showing an inside of a caliper brake in accordance with a third embodiment of the present disclosure when viewed from the side; and

FIG. 6 is a side view showing a side of the caliper brake in accordance with the third embodiment of the present disclosure.

### DETAILED DESCRIPTION OF EMBODIMENTS

Hereinafter, embodiments of the present disclosure will be described in detail with reference to the accompanying drawings. The following embodiments are provided to completely convey the spirit of the present disclosure to those skilled in the art to which the present disclosure pertains. The present disclosure is not limited to the embodiments shown herein and may be embodied in other forms. The drawings are not intended to limit the scope of the present disclosure in any way, and the size of components may be exaggerated for clarity of illustration.

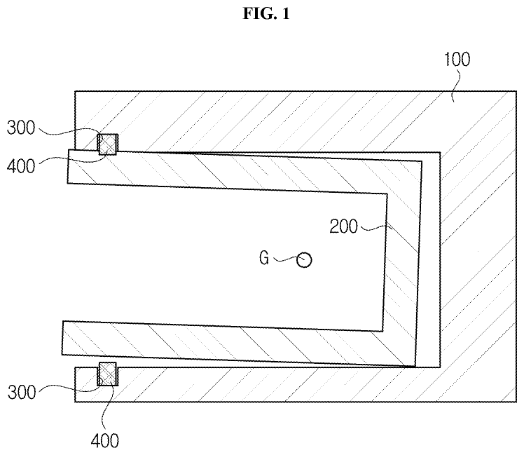

FIG. 1 is a cross-sectional view showing an inside of a caliper brake in the related art.

Referring to FIG. 1, the caliper brake in the related art includes a carrier (not shown), a caliper housing 100, a piston 200, a seal groove 300, and a seal member 400.

In general, a caliper brake is provided with a disc provided to rotate together with a wheel of a vehicle, and a pair of inner pad plates on both sides of the disc. A brake pad directly contacting the disc is fixedly installed on the pad plate.

The carrier (not shown) is fixedly installed to a supportable fixture such as a vehicle body by bolts or the like.

On the carrier (not shown), the pair of pad plates may be installed to be able to move forward to and backward from the disc.

The caliper housing 100 constitutes an exterior of the caliper brake. The caliper housing 100 is slidably installed on the carrier (not shown), and the caliper housing 100 includes a cylinder capable of accommodating the piston 200.

The piston 200 is installed in the cylinder of the caliper housing 100 and is provided to be able to move forward and backward hydraulically or electronically. When the vehicle brakes, the piston 200 moves forward, which moves the pad plate forward. The forward movement of the pad plate causes the brake pad to rub against the disc. On the other hand, when the brake is released and the vehicle starts driving, the piston 200 moves backward and the pad plate also moves backward. Accordingly, the brake pad is spaced apart from the disc.

The seal groove 300 is formed to be recessed in an inner surface of the cylinder, and the seal member 400 is accommodated in the seal groove 300 and is provided to be in close contact with an outer surface of the piston 200. Therefore, the seal member 400 seals a space between the piston 200 and the cylinder and at the same time, performs a rollback operation to return the piston 200 that has moved forward to its original position when braking of the vehicle is released.

In the present disclosure, expressions, such as the inner surface of the cylinder and the outer surface of the piston 200, are used. When the piston 200 is accommodated in the cylinder, the inner side surface of the cylinder positioned close to the piston 200 is referred to as the inner surface of the cylinder, and the outer side surface of the piston 200 positioned close to the inner surface of the cylinder is referred to as the outer surface of the piston 200.

Specifically, for the seal member 400 made of an elastic member such as rubber, deformation occurs when the piston 200 moves forward, and then when the pressure applied for moving the piston 200 forward is released, the piston 200 moves backward as the deformed seal member 400 is restored.

The seal member 400 is provided on the outer surface of the piston 200 and is positioned close to the pad plate. Therefore, the seal member 400 is provided to be spaced apart from the center of gravity G of the piston 200. Accordingly, the piston 200 provides torque to the seal member 400. In particular, when the vehicle maintains a braking state or a driving state, an external force having the same direction and magnitude continuously acts on the seal member 400.

The seal member 400 is made of an elastic material and has relatively low strength compared to the piston 200. Therefore, the seal member 400 in the related art is easily deformed by an external force generated by the weight of the piston 200. An elastic restoring force provided by the seal member 400 to the piston 200 is fully generated when the seal member 400 is in close contact with the outer surface of the piston 200, but the deformed seal member 400 does not come into close contact with the outer surface of the piston 200, which may be a problem. That is, the seal member 400 in the related art is deformed due to the piston 200 and does not generate a full elastic restoring force.

Embodiments according to the present disclosure include a support member 500 to solve the above-mentioned problem. The support member 500 minimizes the external force acting on the seal member 400 due to the weight of the piston 200, thereby preventing deformation of the seal members 400.

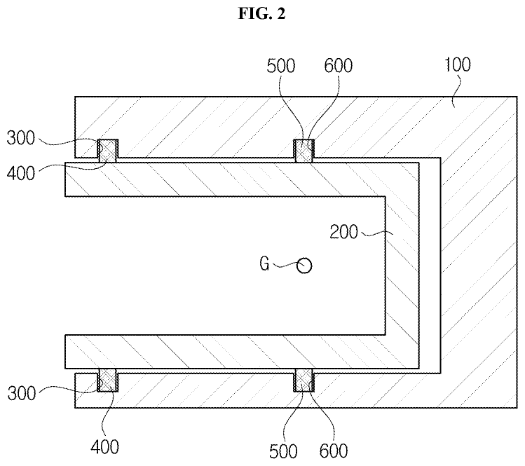

FIG. 2 is a cross-sectional view showing an inside of a caliper brake in accordance with a first embodiment of the present disclosure when viewed from the side.

Referring to FIG. 2, the caliper brake in accordance with the first embodiment of the present disclosure includes a support member 500 and a support member groove 600.

The carrier (not shown), the caliper housing 100, the piston 200, the seal groove 300, and the seal member 400 of the first embodiment of the present disclosure described below are the same as those of the caliper brake in the related art, and thus descriptions thereof will be omitted to avoid duplication of content.

The support member 500 is interposed between the inner surface of the cylinder and the outer surface of the piston 200.

The support member 500 may be disposed adjacent to the center of gravity G of the piston 200, and preferably, may be disposed on an extension line perpendicular to an axial direction of the piston 200 and passing through the center of gravity G of the piston 200.

The support member 500 may be provided in a form of a seal made of an elastic material, and the support member 500 may be provided in an annular shape along the outer surface of the piston 200. One surface of the support member 500 may be fixed to the cylinder, and the other surface may be in close contact with the outer surface of the piston 200.

The support member groove 600 may be formed to be recessed in the inner surface of the cylinder so that the support member 500 is accommodated therein. In a state in which the support member groove 600 is provided, the support member 500 may be accommodated in the support member groove 600, and one surface of the support member 500 may be fixed to the inner surface of the cylinder, and the other surface thereof may be in close contact with the outer surface of the piston 200. When the support member 500 is accommodated in the support member groove 600, there is an advantage in that a fastening force between the support member 500 and the cylinder is improved.

A plurality of support members 500 may be provided. The plurality of support members 500 may be spaced apart from each other along the axial direction of the piston 200, and at the same time, may be symmetrically disposed with respect to the center of gravity G of the piston 200. Therefore, the support members 500 effectively support the piston 200, and the external force acting on the seal member 400 due to the weight of the piston 200 is reduced. That is, due to the support member 500, the deformation of the seal member 400 due to the weight of the piston 200 is reduced, and due to the decrease in the deformation of the seal member 400, the durability of the caliper brake is improved.

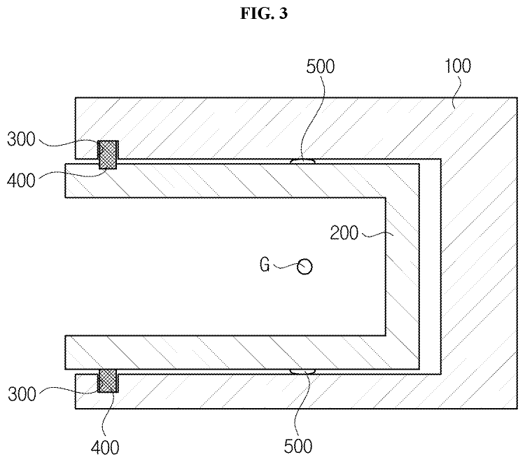

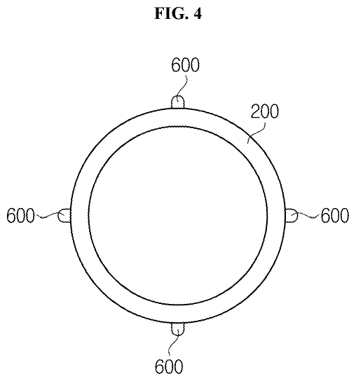

FIG. 3 is a cross-sectional view showing an inside of a caliper brake in accordance with a second embodiment of the present disclosure when viewed from the side, and FIG. 4 is a cross-sectional view showing the inside of the caliper brake in accordance with the second embodiment of the present disclosure when viewed from the front.

The caliper brake in accordance with the second embodiment of the present disclosure to be described below is the same as the caliper brake in accordance with the first embodiment described above, except for parts to be additionally described, and thus descriptions of the same parts will be omitted to avoid duplication of content.

Referring to FIGS. 3 and 4, in the second embodiment of the present disclosure, unlike the first embodiment, the support member groove 600 is not present, and a different support member 500 is provided.

Specifically, the support member 500 in accordance with the second embodiment of the present disclosure has one surface fixed to the outer surface of the piston 200 and the other surface in close contact with the inner surface of the cylinder. In this case, the support member 500 is fixed to the outer surface of the piston 200, and thus, in order to improve a fastening force between the support member 500 and the piston 200, a separate support member groove 600 that is formed to be recessed in the outer surface of the piston 200 to accommodate the support member 500 may be further included.

The support member 500 may be formed so that a center thereof protrudes outward from an edge thereof to allow a part of the other surface to be in contact with the inner surface of the cylinder. Therefore, the support member 500 may minimize the degree of inclination of the piston 200 and at the same time, may minimize the resistance applied to the piston 200 moving forward and backward by the support member 500.

A plurality of support members 500 may be provided. The plurality of support members 500 may be disposed spaced apart from each other around an outer circumferential surface of the piston 200, and the plurality of support members 500 may be radially symmetrically disposed with respect to an axis of the piston 200 as shown in FIG. 4. Therefore, compared to the support member 500 formed in an annular shape in the first embodiment of the present disclosure, resistance applied to the piston 200 moving forward and backward may be minimized.

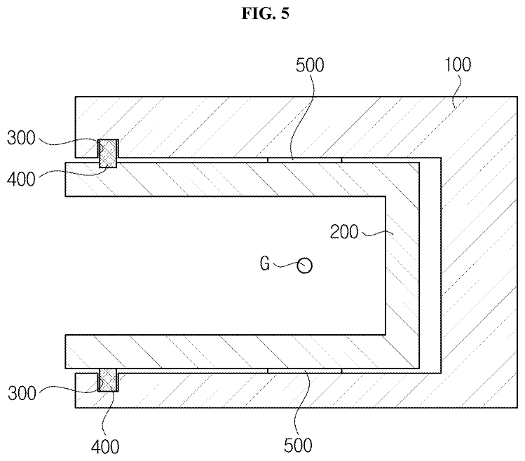

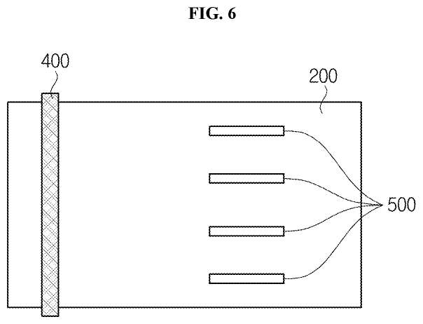

FIG. 5 is a cross-sectional view showing an inside of a caliper brake in accordance with a third embodiment of the present disclosure when viewed from the side, and FIG. 6 is a side view showing a side of the caliper brake in accordance with the third embodiment of the present disclosure.

The caliper brake in accordance with the third embodiment of the present disclosure to be described below is the same as the caliper brake in accordance with the first embodiment described above, except for parts to be additionally described, and thus descriptions of the same parts will be omitted to avoid duplication of content.

Referring to FIGS. 5 and 6, in the third embodiment of the present disclosure, unlike the first embodiment, the support member groove 600 is not present, and a different support member 500 is provided.

Specifically, the support member 500 in accordance with the third embodiment of the present disclosure is provided in a form of a rib. In other words, the support member 500 has the form of the rib extending in the axial direction of the piston 200. Therefore, compared to the support member 500 provided in the form of the seal made of the elastic material in the first and second embodiments of the present disclosure, the third embodiment has a disadvantage of not providing an elastic restoring force to the piston 200 together with the seal member 400. However, it is easy to fix the support member 500 provided in the form of the rib to the piston 200 or the cylinder and the support member 500 provided in the form of the rib supports the piston 200 in a relatively long portion in the axial direction, and thus it is possible to more effectively reduce the external force acting on the seal member 400 due to the weight of the piston 200.

The support member 500 having the form of the rib may be made of a lightweight material.

The support member 500 having the form of the rib may be provided in a round shape so that a surface in contact with the cylinder partially comes into contact with the cylinder. Accordingly, the support member 500 may guarantee smooth bi-directional movement of the piston 200 while supporting the piston 200. That is, the support member 500 having the form of the rib may function as a contact bearing.

A plurality of support members 500 may be provided, and the support members 500 may be provided as a mix of the form of the seal made of an elastic material and the form of the rib extending in the axial direction of the piston 200. When such support members 500 are provided, the support member 500 having the form of the seal and the support member 500 having the form the rib may be alternately disposed. Accordingly, the support member 500 may have both advantages of the form of the seal and the form of the rib.

The caliper brake in accordance with an embodiment of the present disclosure having such a configuration includes the support member 500, and the support member 500 is provided adjacent to the center of gravity G of the piston 200, and thus the external force acting on the seal member 400 having weak durability due to the weight of the piston 200 may be minimized, and accordingly, deformation of the seal member 400 may be minimized. In addition, the support member 500 is provided in the form of the seal or the rib, which may provide a separate advantage. The seal member 400 that is prevented from being deformed may not only provide a full the elastic restoring force to the piston 200, but also improve the durability of the caliper brake, thereby improving the marketability and competitiveness of a vehicle.

As is apparent from the above description, a caliper brake in accordance with one embodiment of the present disclosure has improved durability.

The caliper brake in accordance with one embodiment of the present disclosure prevents deformation of a seal member.

The caliper brake in accordance with one embodiment of the present disclosure allows the seal member to provide a full elastic restoring force to a piston.

The caliper brake in accordance with one embodiment of the present disclosure improves the marketability and competitiveness of a vehicle.

What is claimed is:

1. A caliper brake comprising:
a carrier on which a pair of pad plates are installed to be able to move forward to and backward from a disc;
a caliper housing slidably installed on the carrier and provided with a cylinder;
a piston installed in the cylinder and provided to be able to move forward to and backward from the pair of pad plates by braking hydraulic pressure;
a seal groove formed to be recessed in an inner surface of the cylinder;
a seal member accommodated in the seal groove to be in close contact with an outer surface of the piston; and
a support member interposed between the inner surface of the cylinder and the outer surface of the piston and disposed adjacent to a center of gravity of the piston.

2. The caliper brake according to claim 1, wherein the support member is disposed on an extension line perpendicular to an axial direction of the piston and passing through the center of gravity of the piston.

3. The caliper brake according to claim 1, further comprising a support member groove formed to be recessed in the inner surface of the cylinder so that the support member is accommodated therein.

4. The caliper brake according to claim 1, wherein the support member is provided in a form of a seal made of an elastic material.

5. The caliper brake according to claim 1, wherein one surface of the support member is fixed to the outer surface of the piston, and
the other surface of the support member is in close contact with the inner surface of the cylinder.

6. The caliper brake according to claim 5, wherein the support member is formed so that a center thereof protrudes outward from an edge thereof to allow a part of the other surface to be in contact with the inner surface of the cylinder.

7. The caliper brake according to claim 1, wherein one surface of the support member is fixed to the inner surface of the cylinder, and
the other surface of the support member is in close contact with the outer surface of the piston.

8. The caliper brake according to claim 3, wherein the support member is accommodated in the support member groove so that one surface thereof is fixed to the inner surface of the cylinder, and the other surface of the support member is in close contact with the outer surface of the piston.

9. The caliper brake according to claim 1, wherein the support member is provided in an annular shape along the outer surface of the piston.

10. The caliper brake according to claim 1, wherein a plurality of support members are provided to be disposed spaced apart from each other along an axial direction of the piston.

11. The caliper brake according to claim 1, wherein a plurality of support members are provided to be disposed spaced apart from each other around an outer circumferential surface of the piston.

12. The caliper brake according to claim 10, wherein the support members are symmetrically disposed with respect to the center of gravity of the piston.

13. The caliper brake according to claim 11, wherein the support members are radially symmetrically disposed with respect to an axis of the piston.

14. The caliper brake according to claim 1, wherein the support members are provided in a form of a rib extending in an axial direction of the piston.

15. The caliper brake according to claim 1, wherein a plurality of support members are provided as a mix of a form of a seal made of an elastic material and a form of a rib extending in an axial direction of the piston.
